(19) United States
(12) Patent Application Publication
(10) Pub. No.: US 2013/0027392 A1
(43) Pub. Date: Jan. 31, 2013

(54) IMAGE PROCESSING APPARATUS, IMAGE PROCESSING METHOD, PROGRAM, AND NON-TRANSITORY COMPUTER READABLE INFORMATION STORAGE MEDIUM

(71) Applicant: Tomohiro OTO, Tokyo (JP)

(72) Inventor: Tomohiro OTO, Tokyo (JP)

(73) Assignee: SONY COMPUTER ENTERTAINMENT INC., Tokyo (JP)

(21) Appl. No.: 13/547,315

(22) Filed: Jul. 12, 2012

(30) Foreign Application Priority Data
Jul. 25, 2011 (JP) 2011-162513

(51) Int. Cl. G06T 15/00

(52) U.S. Cl. 345/419

(57) ABSTRACT

Provided is a technology that enables control selection as to which of a raster image for three-dimensional display, which is generated based on a raster image drawn in a memory, and the raster image drawn in the memory is to be displayed without forcing a user to do complicated work. A drawing unit draws a raster image generated based on data serving as a basis of the raster image into the memory. A pseudo-three-dimensional rendering control unit performs control as to which of the raster image drawn in the memory and a raster image for three-dimensional display based on the raster image drawn in the memory is to be displayed on a display device, in accordance with the drawing of the raster image based on the data serving as the basis of the raster image into the memory.

### CROSS-REFERENCE TO RELATED APPLICATION

The present application claims priority from Japanese application JP 2011-162513 filed on Jul. 25, 2011, the content of which is hereby incorporated by reference into this application.

### BACKGROUND OF THE INVENTION

1. Field of the Invention

The present invention relates to an image processing apparatus, an image processing method, a program, and a non-transitory information storage medium.

2. Description of the Related Art

There exists a technology for generating raster images for three-dimensional display (a raster image for a left eye and a raster image for a right eye) based on data representing an object and a viewpoint, which are located within a virtual three-dimensional space. When the thus-generated raster image for three-dimensional display is input to a display device that implements a three-dimensional image display unit by, for example, a frame sequential method, a passive glass method, a parallax barrier method, or other such method, the raster image indicating how the object is viewed from the viewpoint located within the virtual three-dimensional space is displayed on the display device three-dimensionally.

Further, there exist image processing apparatus that can perform pseudo-three-dimensional rendering processing for generating a raster image for three-dimensional display based on a two-dimensional raster image. Also when the thus-generated raster image for three-dimensional display is input to the display device, the raster image is displayed on the display device three-dimensionally. Further, there exist display devices that perform the pseudo-three-dimensional rendering processing on the input two-dimensional raster image and generate the raster image for three-dimensional display to display the image three-dimensionally. Some of those image processing apparatus and display devices allow switchover as to whether or not to execute the pseudo-three-dimensional rendering processing in accordance with an operation input received from a user.

### SUMMARY OF THE INVENTION

For example, in a situation in which an image generated by a game program being executed through a game console or the like is being displayed on the display device, under the condition that the raster image for three-dimensional display is generated based on the data representing the object and the viewpoint, which are located within the virtual three-dimensional space, and is drawn in the memory, it is unnecessary to execute the pseudo-three-dimensional rendering processing on the raster image drawn in the memory in the first place. Meanwhile, in the above-mentioned situation, under the condition that a moving image such as a flashback scene is reproduced, frame images are displayed three-dimensionally if displayed on the display device after the pseudo-three-dimensional rendering processing is executed on the frame images included in the moving image.

Further, for example, in a situation in which the frame images included in the moving image are sequentially being displayed on the display device, the frame images that do not include textual information are three-dimensionally displayed if displayed on the display device after the pseudo-three-dimensional rendering processing is executed on the frame images. Meanwhile, in the above-mentioned situation, the frame images that include textual information may deteriorate in visibility of the textual information if displayed on the display device after the pseudo-three-dimensional rendering processing is executed on the frame images.

Further, for example, in a case where different loads are imposed on the pseudo-three-dimensional rendering processing depending on a type (for example, whether or not a person can be detected or whether or not the image is a natural image) or the like of the raster image drawn in the memory, a series of raster images to be displayed may include a mixture of the raster image that exerts a heavy load on the pseudo-three-dimensional rendering processing and the raster image that exerts a light load on the pseudo-three-dimensional rendering processing. In such a case, it is desired that the pseudo-three-dimensional rendering processing be inhibited from being executed on the raster image that exerts a high load on the pseudo-three-dimensional rendering processing.

In the above-mentioned situation in which the series of raster images to be displayed include the mixture of the raster image that is desired to be subjected to the execution of the pseudo-three-dimensional rendering processing and the raster image that is not, when the switchover as to whether or not to execute the pseudo-three-dimensional rendering processing is performed in accordance with the user's operation input, the user is forced to do complicated work. In the above-mentioned situation, it is desired that selection as to whether or not to execute the pseudo-three-dimensional rendering processing be controlled in accordance with drawing of a raster image based on data serving as a basis of the raster image into the memory (for example, whether or not the drawn image is the raster image for three-dimensional display, whether or not an executed command includes a graphics command instructing to draw the raster image for three-dimensional display, whether or not the executed command includes a command to decode encoded moving image data, type of the memory in which the raster image is drawn, type of the raster image, or type of the data serving as the basis for generating the raster image).

The present invention has been made in view of the above-mentioned problems, and an object of some embodiments of the invention is to control, without forcing a user to do complicated work, selection as to which of a raster image for three-dimensional display, which is generated based on a raster image drawn in the memory, and the raster image drawn in the memory is to be displayed.

In order to solve the above-mentioned problems, according to an exemplary embodiment of the present invention, there is provided an image processing apparatus, including: a drawing unit that draws a raster image generated based on data serving as a basis of the raster image into a memory; and a control unit that performs control as to which of the raster image drawn in the memory and a raster image for three-dimensional display based on the raster image drawn in the memory is to be displayed on a display device, in accordance with the drawing of the raster image based on the data into the memory.

Further, according to an exemplary embodiment of the present invention, there is provided an image processing method, including: drawing a raster image generated based on data serving as a basis of the raster image into a memory; and performing control as to which of the raster image drawn in the memory and a raster image for three-dimensional display based on the raster image drawn in the memory is to be displayed on a display device, in accordance with the drawing of the raster image based on the data into the memory.

Further, according to an exemplary embodiment of the present invention, there is provided a program stored in a non-transitory computer readable information storage medium, which is to be executed by a computer, the program including instructions to: draw a raster image generated based on data serving as a basis of the raster image into a memory; and perform control as to which of the raster image drawn in the memory and a raster image for three-dimensional display based on the raster image drawn in the memory is to be displayed on a display device, in accordance with the drawing of the raster image based on the data into the memory.

Further, according to an exemplary embodiment of the present invention, there is provided a non-transitory computer readable information storage medium storing a program which is to be executed by a computer, the program including instructions to: draw a raster image generated based on data serving as a basis of the raster image into a memory; and perform control as to which of the raster image drawn in the memory and a raster image for three-dimensional display based on the raster image drawn in the memory is to be displayed on a display device, in accordance with the drawing of the raster image based on the data into the memory.

According to the present invention, in accordance with the drawing of the raster image based on the data serving as the basis of the raster image into the memory, the selection as to which of the raster image drawn in the memory and the raster image for three-dimensional display based on the raster image drawn in the memory is to be displayed on the display device is controlled, and hence it is possible to control, without forcing the user to do complicated work, the selection as to which of the raster image for three-dimensional display, which is generated based on the raster image drawn in the memory, and the raster image drawn in the memory is to be displayed.

According to the exemplary embodiment of the present invention, the control unit causes the display device to display the raster image drawn in the memory under the condition that the raster image for three-dimensional display is drawn into the memory by the drawing unit.

Further, according to the exemplary embodiment of the present invention, the control unit causes the display device to display the raster image drawn in the memory under the condition that commands executed during a period from acquisition of the data serving as the basis of the raster image until the drawing of the raster image based on the data include a graphics command instructing to draw the raster image for three-dimensional display, and otherwise, causes the display device to display the raster image for three-dimensional display based on the raster image drawn in the memory.

Further, according to the exemplary embodiment of the present invention, the control unit causes the display device to display the raster image for three-dimensional display based on the raster image drawn in the memory under the condition that the commands executed during a period from acquisition of the data serving as the basis of the raster image until the drawing of the raster image based on the data include a command to decode encoded moving image data, and otherwise, causes the display device to display the raster image drawn in the memory.

Further, according to the exemplary embodiment of the present invention, the control unit performs the control based on a type of the memory in which the raster image is drawn by the drawing unit.

Further, according to the exemplary embodiment of the present invention, the control unit performs the control based on an attribute of the data or an attribute of the raster image.

Further, according to the exemplary embodiment of the present invention, the image processing apparatus further includes a raster image for three-dimensional display generation unit that generates the raster image for three-dimensional display based on the raster image drawn in the memory in a case where the control unit performs control to cause the display device to display the raster image for three-dimensional display based on the raster image drawn in the memory.

### BRIEF DESCRIPTION OF THE DRAWINGS

In the accompanying drawings:

FIG. 1 is a diagram illustrating a configuration of an image processing apparatus according to one embodiment of the present invention;

FIG. 2 is a functional diagram illustrating an example of functions implemented by the image processing apparatus according to the embodiment of the present invention;

FIG. 3 is a diagram illustrating an example of a virtual space;

FIG. 4A is a flowchart illustrating an example of a flow of processing performed by the image processing apparatus according to the embodiment of the present invention; and

FIG. 4B is a flowchart illustrating an example of the flow of the processing performed by the image processing apparatus according to the embodiment of the present invention.

### DETAILED DESCRIPTION OF THE INVENTION

Hereinafter, an embodiment of the present invention is described in detail with reference to the accompanying drawings.

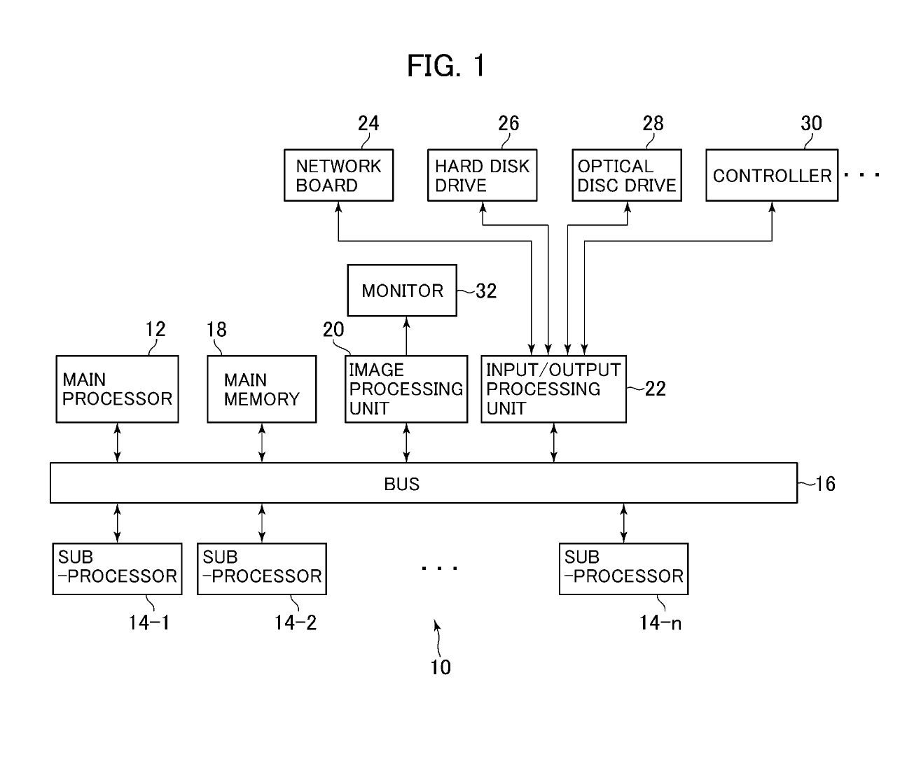

FIG. 1 is a configuration diagram of an image processing apparatus 10 according to the embodiment of the present invention. As illustrated in FIG. 1, a control unit of the image processing apparatus 10 according to this embodiment includes a main processor 12 and a plurality of sub-processors 14 (14-1, 14-2, . . . , and 14-n). The main processor 12 and the sub-processors 14 are each connected to a bus 16, and are configured to transmit/receive data to/from each other via the bus 16. The bus 16 is further connected to a main memory 18 and an image processing unit 20. The bus 16 is also connected to a network board 24, a hard disk drive 26, an optical disc drive 28, a controller 30, and the like via an input/output processing unit 22. Note that, the input/output processing unit 22 may also be connected to other units (for example, a universal serial bus (USB) port, a camera unit, speakers, and a microphone).

The main processor 12 executes a program for a system or the like, and based on a program and data which are stored on a hard disk read from a hard disk drive 26 or on an optical disc read from an optical disc drive 28, a program and data supplied through a communication network, or the like, performs various kinds of information processing or performs control on the sub-processor 14. The sub-processor 14 performs the various kinds of information processing in accordance with an instruction from the main processor 12, or controls the respective units of the image processing apparatus 10 based on the program and data stored on the hard disk or the optical disc, the program and data supplied through the communication network, or the like. Further, in this embodiment, the sub-processor 14 has a direct memory access controller (DMAC) built thereinto, and is configured to directly access the main memory 18 without the intermediation of the main processor 12.

The program and data stored on the hard disk or the optical disc, the program and data supplied through the communication network, or the like are written to the main memory 18 as necessary. The main memory 18 is also used as a work memory for the main processor 12 and the sub-processor 14. Further, in this embodiment, the main memory 18 also stores a game program or an emulator program to be installed on the image processing apparatus 10 according to this embodiment.

The image processing unit 20 includes a graphical processing unit (GPU) and a frame buffer. The GPU draws an image in the frame buffer based on a graphics command and data supplied from the main processor 12 and the sub-processor 14. The image drawn in the frame buffer is converted into a video signal at a predetermined timing and output to a monitor 32. In this embodiment, a home-use television set, a liquid crystal display, or the like is used as the monitor 32. In this embodiment, the image processing unit 20 and the monitor 32 are connected by a high-definition multimedia interface (HDMI) cable. Further, in this embodiment, the image processing unit 20 converts the image drawn in a frame buffer into a video signal of HDMI at a predetermined timing and outputs the video signal to the monitor 32.

The monitor 32 according to this embodiment is configured to perform three-dimensional image display (3D display) by a frame sequential method in which a raster image for a left eye and a raster image for a right eye are alternately displayed.

The input/output processing unit 22 is connected to the network board 24, the hard disk drive 26, the optical disc drive 28, the controller 30, and the like. The input/output processing unit 22 controls data exchange between the main processor 12 or the sub-processor 14, and the network board 24, the hard disk drive 26, the optical disc drive 28, the controller 30, or the like.

The network board 24 is connected to the input/output processing unit 22 and a network, and relays data communication performed by the image processing apparatus 10 to/from an external portion via the network. The optical disc drive 28 reads a program and data stored on the optical disc such as a DVD-ROM or a Blu-ray (registered trademark) disc in accordance with instructions from the main processor 12 and/or the sub-processor 14. Further, the hard disk drive 26 is a general hard disk drive, and reads a program and data stored on a hard disk. The optical disc and the hard disk have various programs and data stored thereon in a computer readable manner. Note that, the image processing apparatus 10 may be configured to be able to read a program and data stored on a non-transitory computer readable information storage medium other than the optical disc or the hard disk. The controller 30 is a general-purpose operation input unit, and is used by a user for inputting various operations. The input/output processing unit 22 scans a state of each of the units of the controller 30 every predetermined time (for example, every 1/60th of a second), and supplies an operation state indicating a result thereof to the main processor 12 and/or the sub-processor 14. The main processor 12 and/or the sub-processor 14 determine the content of the operation performed by the user based on the operation state.

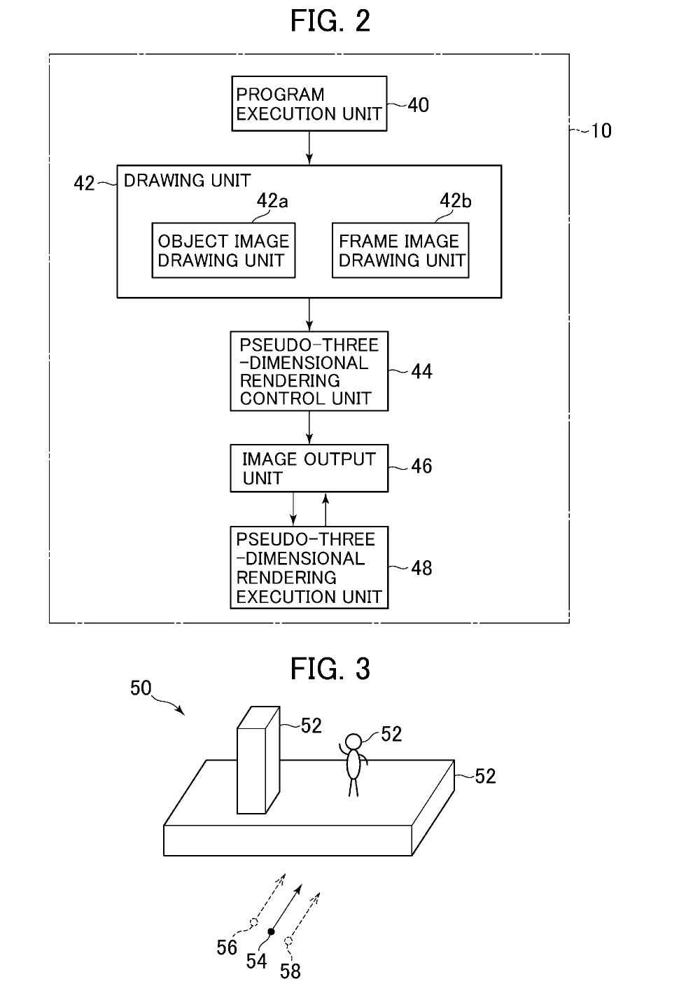

FIG. 2 is a functional block diagram illustrating an example of functions implemented by the image processing apparatus 10 according to this embodiment. Note that, on the image processing apparatus 10 according to this embodiment, functions other than the functions illustrated in FIG. 2 are also implemented. As illustrated in FIG. 2, the image processing apparatus 10 functionally includes a program execution unit 40, a drawing unit 42, a pseudo-three-dimensional rendering control unit 44, an image output unit 46, and a pseudo-three-dimensional rendering execution unit 48. In addition, the drawing unit 42 includes an object image drawing unit 42a and a frame image drawing unit 42b. The program execution unit 40 and the frame image drawing unit 42b are mainly implemented by the main processor 12 and/or the sub-processor 14. The object image drawing unit 42a, the pseudo-three-dimensional rendering control unit 44, and the image output unit 46 are mainly implemented by the image processing unit 20. The pseudo-three-dimensional rendering execution unit 48 is mainly implemented by the sub-processor 14.

Those functions are implemented by the execution of a program according to this embodiment by the image processing apparatus 10. The program may be downloaded from another computer through an communication interface via a computer communication network, or may be stored on a non-transitory computer readable information storage medium such as an optical disc (for example, CD-ROM or DVD-ROM) or a USB memory and installed onto the image processing apparatus 10 therefrom through the optical disc drive 28, the USB port, or the like.

In addition, on the image processing apparatus 10 according to this embodiment, it is previously set which of two-dimensional display and three-dimensional display is employed to output the image to the monitor 32. Here, on the image processing apparatus 10 according to this embodiment, it is assumed that it is previously set that the three-dimensional display is employed to output the image.

Further, on the image processing apparatus 10 according to this embodiment, drawing of a raster image and displaying of the raster image on the monitor 32 are performed every predetermined time interval (for example, every 1/60th of a second).

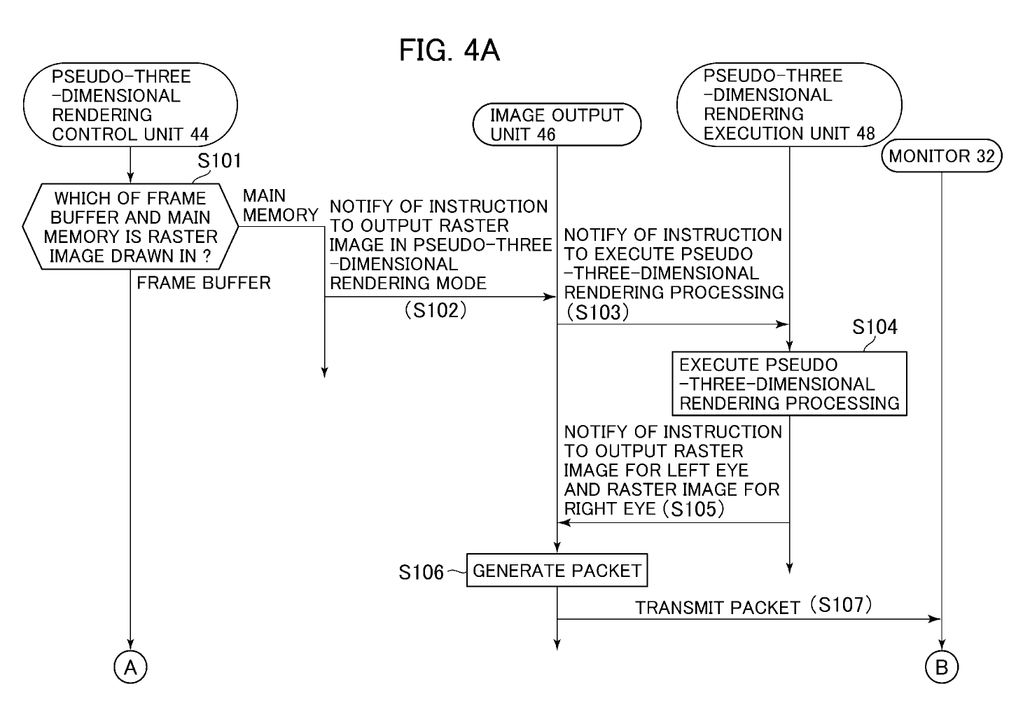

The program execution unit 40 executes a game program installed on the image processing apparatus 10 (the game program stored on a hard disk read by the hard disk drive 26 or an optical disc read by the optical disc drive 28). The image processing apparatus 10 according to this embodiment builds a virtual space 50 exemplified in FIG. 3 on the main memory 18 by executing the above-mentioned game program. The program execution unit 40 generates a virtual object 52 based on vector data expressing points, lines, polygons, and the like, and disposes the generated virtual object 52 within the virtual space 50. Further, the program execution unit 40 disposes the viewpoint 54 within the virtual space 50 based on data representing a position of a viewpoint 54 and a line-of-sight direction thereof. In this embodiment, the virtual object 52 is constituted by a plurality of polygons. Textures are mapped to the respective polygons. The above-mentioned vector data and the data representing the position of the viewpoint 54 and the line-of-sight direction are previously stored on the hard disk read by the hard disk drive 26 or the optical disc read by the optical disc drive 28.

Then, the program execution unit 40 outputs a graphics command instructing to draw a raster image (bitmap image) rendering a scene viewed from the viewpoint 54 in the line-of-sight direction to the object image drawing unit 42a. The graphics command is associated with data representing the position in which the virtual object 52 is disposed and the data representing the position of the viewpoint 54 and the line-of-sight direction.

When the above-mentioned graphics command is received from the program execution unit 40, the object image drawing unit 42a generates: a raster image for a left eye which indicates how the virtual space 50 is viewed from a position obtained by shifting the position of the viewpoint 54 received from the program execution unit 40 leftward by a predetermined length (left viewpoint 56 illustrated in FIG. 3); and a raster image for a right eye which indicates how the virtual space 50 is viewed from a position obtained by shifting the position of the viewpoint 54 received from the program execution unit 40 rightward by a predetermined length (right viewpoint 58 illustrated in FIG. 3), and draws those raster images into each of frame buffers corresponding thereto. In this manner, the image processing unit 20 according to this embodiment includes the frame buffer in which the raster image for the left eye is drawn and the frame buffer in which the raster image for the right eye is drawn.

Further, under the condition that a predetermined event occurs during execution of the game program, the program execution unit 40 is brought to a state in which a moving image such as a flashback scene is reproduced. Under the condition that such a state becomes effective, the program execution unit 40 acquires encoded moving image data which is stored on the hard disk or the optical disc. Then, the frame image drawing unit 42b decodes the acquired moving image data and then draws a series of frame images constituting the moving image data in the main memory 18. Note that, the frame image is a raster image (bitmap image).

In this embodiment, under the condition that reproduction of the moving image is finished, the program execution unit 40 resumes outputting the graphics command instructing to draw the raster image (bitmap image) rendering a scene viewed from the viewpoint 54 in the line-of-sight direction to the object image drawing unit 42a, and the object image drawing unit 42a resumes drawing the raster image for the left eye and the raster image for the right eye into the frame buffers.

In accordance with the drawing of the raster image, the pseudo-three-dimensional rendering control unit 44 controls selection as to which of the raster image in the normal mode and the raster image in a pseudo-three-dimensional rendering mode the image output unit 46 is to be caused to output. In this embodiment, the normal mode indicates a mode in which the drawn raster image is output to the monitor 32, and the pseudo-three-dimensional rendering mode indicates a mode in which a raster image for three-dimensional display generated based on the drawn raster image (for example, a combination of the raster image for the left eye and the raster image for the right eye) is output to the monitor 32.

The image output unit 46 outputs the raster image drawn in the frame buffer or the main memory 18 to the monitor 32 in any one of the normal mode and the pseudo-three-dimensional rendering mode.

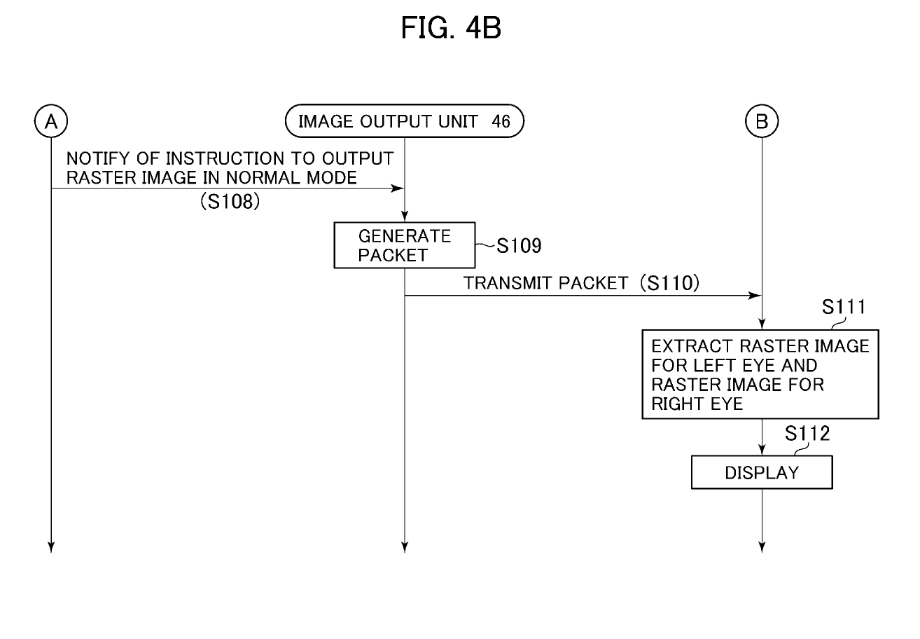

Here, referring to flowcharts exemplified in FIG. 4A and FIG. 4B, a description is made of an example of a flow of processing for outputting the raster image drawn in the frame buffer or the main memory 18 to the monitor 32, which is performed by the image processing apparatus 10 according to this embodiment.

First, based on an address within the memory in which a raster image to be output is drawn, the pseudo-three-dimensional rendering control unit 44 identifies which of the frame buffer and the main memory 18 the raster image is drawn in (S101). Under the condition that it is identified that the raster image to be output is drawn in the main memory 18, the pseudo-three-dimensional rendering control unit 44 notifies the image output unit 46 of an instruction to output the raster image in the pseudo-three-dimensional rendering mode (S102). Then, in response to the received notification, the image output unit 46 notifies the pseudo-three-dimensional rendering execution unit 48 of an instruction to generate the raster image for three-dimensional display based on the raster image to be output (instruction to execute pseudo-three-dimensional rendering processing) (S103). Then, in response to the received notification, the pseudo-three-dimensional rendering execution unit 48 generates the combination of the raster image for the left eye and the raster image for the right eye based on the raster image to be output (executes the pseudo-three-dimensional rendering processing) (S104). Then, the pseudo-three-dimensional rendering execution unit 48 notifies the image output unit 46 of an instruction to output the raster image for the left eye and the raster image for the right eye which are generated by the processing illustrated in Step S104 (S105). Then, in response to this notification, the image output unit 46 generates a packet including the raster image for the left eye and the raster image for the right eye which are generated by the pseudo-three-dimensional rendering execution unit 48, the packet conforming to a frame packing method via HDMI (S106). Note that, the frame packing method is one of 3D-picture signal transmission schemes via HDMI 1.4. Then, the image output unit 46 transmits the generated packet to the monitor 32 (S107). Note that, in this embodiment, the generation and output of the combination of the raster image for the left eye and the raster image for the right eye based on the raster image drawn in the main memory 18 are performed through direct memory access (DMA) effected by a DMAC of the sub-processor 14 without the intermediation of the frame buffer.

Meanwhile, under the condition that it is identified in the processing illustrated in Step S101 that the raster image to be output is drawn in the frame buffer, the pseudo-three-dimensional rendering control unit 44 notifies the image output unit 46 of an instruction to output the raster image in the normal mode (S108). Then, in response to the received notification, the image output unit 46 generates the packet including the raster image to be displayed (S109). Then, the image output unit 46 transmits the generated packet to the monitor 32 (S110).

In this embodiment, as described above, the raster image for the left eye which indicates how the virtual space 50 is viewed from the left viewpoint 56 and the raster image for the right eye which indicates how the virtual space 50 is viewed from the right viewpoint 58 are generated by the object image drawing unit 42a and drawn in each of the frame buffers corresponding thereto, and hence in the processing illustrated in Step S109, the image output unit 46 generates the packet conforming to the frame packing method via HDMI and including the raster image for the left eye and the raster image for the right eye.

Then, upon reception of the packet transmitted in the processing illustrated in Step S107 or Step S110, the monitor 32 interprets the packet in conformity with the frame packing method via HDMI to thereby extract the raster image for the left eye and the raster image for the right eye from the received packet (S111). Then, the monitor 32 three-dimensionally displays the raster image for the left eye and the raster image for the right eye by a frame sequential method (S112).

On the image processing apparatus 10 according to this embodiment, the drawing of the raster image into the frame buffer or the main memory 18 and the above-mentioned processing illustrated in Steps S101 to S112 are executed every predetermined time interval. Note that, a method of transmitting a packet by the image output unit 46 in the above-mentioned processing example is not limited to the frame packing method, and, for example, another 3D-picture signal transmission scheme such as a side-by-side method or a top-and-bottom method may be used.

As described above, on the image processing apparatus 10 according to this embodiment, under the condition that the raster image to be displayed is a frame image constituting the moving image data and under the condition that the raster image being the frame image is drawn in the main memory 18, the raster image for the left eye and the raster image for the right eye which are generated based on the raster image (generated by the pseudo-three-dimensional rendering processing) are displayed on the monitor 32. Meanwhile, on the image processing apparatus 10 according to this embodiment, under the condition that the raster image to be displayed is a raster image generated based on the vector data and under the condition that this raster image is drawn in the frame buffer, the raster image for the left eye and the raster image for the right eye which are generated by the image processing unit 20 are displayed on the monitor 32. In this case, the pseudo-three-dimensional rendering processing to be performed by the pseudo-three-dimensional rendering execution unit 48 is not executed. In this manner, in this embodiment, without forcing a user to do complicated work, it is possible to control, based on the type of the memory in which the raster image is drawn, the selection as to which of the raster image for three-dimensional display, which is generated based on the raster image to be drawn, and the raster image drawn in the memory is to be displayed on the monitor 32. Further, according to this embodiment, it is possible to prevent such an event that the pseudo-three-dimensional rendering processing is executed on the raster image for the left eye and the raster image for the right eye which are generated by the image processing unit 20.

Further, an emulator can be executed on the image processing apparatus 10 according to this embodiment. The emulator is a process functioning as a virtual machine for executing a program that can be executed by an apparatus including a processor of a different type from that of the image processing apparatus 10 (hereinafter, referred to as “apparatus of another type”). The emulator is generated by activating the emulator program installed on the image processing apparatus 10 according to this embodiment.

The emulator according to this embodiment emulates two types of processor (central processing unit (CPU) and graphical processing unit (GPU)) included in the apparatus of another type. In the following description, a CPU provided to the apparatus of another type is referred to as a CPU of another type, and a GPU provided to the apparatus of another type is referred to as a GPU of another type. The main processor 12 and the sub-processor 14 provided to the image processing apparatus 10 according to this embodiment and the CPU of another type are different in instruction set. Further, the GPU included in the image processing unit 20 provided to the image processing apparatus 10 according to this embodiment and the GPU of another type are also different in instruction set.

In this embodiment, processing related to the emulation of the CPU of another type is executed by the main processor 12. Further, in this embodiment, a graphics command output by the emulated CPU of another type (graphics command that can be executed by the GPU of another type) is written to the main memory 18. Then, the sub-processor 14 converts the graphics command written to the main memory 18 into a graphics command that can be executed by the GPU included in the image processing unit 20 of the information image apparatus 10. Then, the image processing unit 20 executes the converted graphics command.

Further, in this embodiment, with regard to a specific command (in this case, for example, no operation (NOP) command) for a processor of another type, the emulator according to this embodiment performs processing corresponding to the value of the parameter (for example, operand) set in the command. Therefore, for example, in a case where generation processing for the raster images for three-dimensional display (raster image for the left eye and raster image for the right eye) based on the vector data is set as the value of the parameter set in the NOP command for the processor of another type, the generation processing is executed on the image processing apparatus 10 according to this embodiment even if the generation processing cannot be executed on the apparatus of another type. Under the condition that processing corresponding to the above-mentioned NOP command is executed by the emulator, the sub-processor 14 outputs the graphics command instructing to draw the raster image for three-dimensional display to the image processing unit 20. Then, the image processing unit 20 generates the raster image for the left eye and the raster image for the right eye, and draws those raster images into each of the frame buffers corresponding thereto.

Then, in this embodiment, for example, under the condition that the situation in which the moving image is being reproduced in the game program executed on the emulator is effected, the emulator draws a series of frame images constituting the moving image data into the main memory 18.

Then, in this embodiment, even under the condition that the game program is being executed by the emulator, in the case where the raster image to be output is drawn in the main memory 18, the pseudo-three-dimensional rendering control unit 44 notifies the image output unit 46 of the instruction to output the raster image in the pseudo-three-dimensional rendering mode, and in the case where the raster image to be output is drawn in the frame buffer, notifies the image output unit 46 of the instruction to output the raster image in the normal mode. Under the condition that the image output unit 46 is notified of the instruction to output the raster image in the pseudo-three-dimensional rendering mode, the same processing or the similar processing as the above-mentioned processing illustrated in Steps S103 to S107, S111, and S112 are executed. Under the condition that the image output unit 46 is notified of the instruction to output the raster image in the normal mode, the same processing or the similar processing as the above-mentioned processing illustrated in Steps S109 to S112 are executed.

In this manner, even in the case where the program is executed by the emulator on the image processing apparatus 10 according to this embodiment, without forcing the user to do complicated work, it is possible to control, based on the type of the memory in which the raster image is drawn, the selection as to which of the raster image for three-dimensional display, which is generated based on the raster image to be drawn, and the raster image drawn in the memory is to be displayed on the monitor 32.

Note that, the present invention is not limited to the above-mentioned embodiment.

For example, in a scene in which the moving image such as a movie constituted by a series of frame images is being reproduced by the image processing apparatus 10, the pseudo-three-dimensional rendering control unit 44 maybe configured to use a known character recognition technology to determine whether or not the above-mentioned frame image drawn in the main memory 18 includes textual information. Then, the pseudo-three-dimensional rendering control unit 44 may be configured to notify the image processing unit 20 of the instruction to output the raster image in the normal mode under the condition that it is determined that the frame image includes textual information, and under the condition that it is determined that the frame image does not include textual information, notify the image output unit 46 of the instruction to output the raster image in the pseudo-three-dimensional rendering mode. In this manner, the frame image including textual information is not displayed three-dimensionally on the monitor 32, which can prevent deterioration in visibility of textual information.

Further, a relationship between a feature and/or an attribute of the raster image, and, a load on the pseudo-three-dimensional rendering processing may be identified based on the type of an algorithm used for the pseudo-three-dimensional rendering processing executed by the pseudo-three-dimensional rendering execution unit 48 (for example, algorithm for identifying a depth of each pixel based on a difference between the raster image to be displayed and a raster image displayed in the previous frame or algorithm for setting a depth of an area of a shape set in advance as a template as the value associated with this template). In such a case, for example, the hard disk or the main memory 18 may be configured to previously store data indicating conditions related to the feature and/or the attribute of the raster image that exerts a relatively light processing load (for example, being a natural image, being capable of detecting a person, or having a difference in feature amount from the raster image in the previous frame less than a predetermined amount). Then, the pseudo-three-dimensional rendering control unit 44 may be configured to analyze the raster image to be displayed by using, for example, a known image processing technology. Then, based on an analysis result, the pseudo-three-dimensional rendering control unit 44 maybe configured to notify the image output unit 46 of the instruction to output the raster image in the pseudo-three-dimensional rendering mode under the condition that it is determined that the raster image satisfies the condition indicated by the stored data, and otherwise, notify the image output unit 46 of the instruction to output the raster image in the normal mode.

As described above, based on the attribute of data serving as a basis for generating a raster image and/or the attribute of the raster image, the pseudo-three-dimensional rendering control unit 44 may be configured to decide which of the instruction to output the raster image in the pseudo-three-dimensional rendering mode and the instruction to output the raster image in the normal mode to notify the image output unit 46 of.

Further, for example, the pseudo-three-dimensional rendering control unit 44 may be configured to notify the image processing unit 20 of the instruction to output the raster image in the normal mode under the condition that commands executed by the image processing apparatus 10 during a period from the acquisition of the data serving as the basis for generating a raster image output from the image output unit 46 until the drawing of the raster image include the graphics command instructing to draw the raster image for three-dimensional display based on the vector data or the moving image data (for example, to draw the raster image for the left eye and the raster image for the right eye), and otherwise, notify the image output unit 46 of the instruction to output the raster image in the pseudo-three-dimensional rendering mode.

Further, for example, the pseudo-three-dimensional rendering control unit 44 may be configured to notify the image output unit 46 of the instruction to output the raster image in the pseudo-three-dimensional rendering mode under the condition that the commands executed by the image processing apparatus 10 during the period from the acquisition of the data serving as the basis for generating a raster image output from the image output unit 46 until the drawing of the raster image include a command to decode encoded moving image data, and otherwise, notify the image processing unit 20 of the instruction to output the raster image in the normal mode.

Further, for example, the pseudo-three-dimensional rendering control unit 44 may be configured to notify the image output unit 46 of the instruction to output the raster image in the pseudo-three-dimensional rendering mode under the condition that the data serving as the basis for generating the raster image output from the image output unit 46 is the frame image output from the optical disc, and otherwise, notify the image processing unit 20 of the instruction to output the raster image in the normal mode.

Further, for example, the pseudo-three-dimensional rendering control unit 44 may be configured to notify the image processing unit 20 of the instruction to output the raster image in the normal mode under the condition that the number of raster images to be displayed is two, i.e., raster images to be displayed are the raster image for the left eye and the raster image for the right eye, and otherwise, notify the image output unit 46 of the instruction to output the raster image in the pseudo-three-dimensional rendering mode.

Also in the above description, under the condition that the image output unit 46 is notified of the instruction to output the raster image in the pseudo-three-dimensional rendering mode, the same processing or the similar processing as the above-mentioned processing illustrated in Steps S103 to S107, S111, and S112 is executed, and under the condition that the image output unit 46 is notified of the instruction to output the raster image in the normal mode, the same processing or the similar processing as the above-mentioned processing illustrated in Steps S109 to S112 is executed.

Further, for example, in a case where the number of raster images to be displayed is one when the instruction to output the raster image in the normal mode is received from the pseudo-three-dimensional rendering control unit 44, the image output unit 46 may be configured to generate the packet conforming to the frame packing method via HDMI, in which the same image as the raster image is included both as the raster image for the left eye and as the raster image for the right eye, and transmit the generated packet to the monitor 32. Further, in a case where the number of raster images to be displayed is one when the instruction to output the raster image in the normal mode is received from the pseudo-three-dimensional rendering control unit 44, the image output unit 46 may be configured to transmit the raster image to be displayed to the monitor 32 by using a 2D-picture signal transmission scheme without using the 3D-picture signal transmission scheme.

Further, on the image processing apparatus 10 according to this embodiment, in accordance with the user's operation input received from the controller 30, it may be possible to set whether or not to execute the pseudo-three-dimensional rendering processing. Here, when it is set that the pseudo-three-dimensional rendering processing is not to be executed, while avoiding the above-mentioned control from being performed by the pseudo-three-dimensional rendering control unit 44, the image output unit 46 may be configured to generate a packet including the raster image drawn in the frame buffer or the main memory 18 and transmit the packet to the monitor 32. At this time, the image output unit 46 may be configured to transmit the raster image to be displayed to the monitor 32 by using the 3D-picture signal transmission scheme, or may be configured to transmit the raster image to be displayed to the monitor 32 by using the 2D-picture signal transmission scheme.

Further, on the image processing apparatus 10 according to this embodiment, in accordance with the user's operation input received from the controller 30, it may be possible to set whether or not to execute three-dimensional display. Here, under the condition that it is set that the three-dimensional display is not to be executed, the object image drawing unit 42a maybe configured to draw the raster image rendering a scene of the virtual space 50 viewed from the viewpoint 54 into the frame buffer. Then, the image output unit 46 maybe configured to transmit the raster image to be displayed to the monitor 32 by using the 2D-picture signal transmission scheme.

For example, a method of realizing the 3D display on the monitor 32 is not limited to the frame sequential method. For example, the monitor 32 maybe configured to realize the 3D display by a passive glass method of changing a polarization characteristic for each horizontal scan line. Further, the monitor 32 may be naked-eye 3D display that realizes the 3D display by a parallax barrier method.

Further, the image processing apparatus 10 does not need to include the monitor 32, and the image processing apparatus 10 may be configured to output the above-mentioned packet to the monitor 32 connected to the image processing apparatus 10.

Further, the pseudo-three-dimensional rendering processing maybe avoided from being executed by the pseudo-three-dimensional rendering execution unit 48. Instead thereof, the image processing unit 20 may be configured to output an instruction to execute the pseudo-three-dimensional rendering processing to the monitor 32 capable of executing the pseudo-three-dimensional rendering processing along with the raster image to be displayed. Then, the monitor 32 may be configured to execute the pseudo-three-dimensional rendering processing on the raster image received along with the instruction to execute the pseudo-three-dimensional rendering processing, generate the raster image for the left eye and the raster image for the right eye, and display the raster image for the left eye and the raster image for the right eye that have been generated.

Further, the functions of the program execution unit 40, the drawing unit 42, the pseudo-three-dimensional rendering control unit 44, the image output unit 46, and the pseudo-three-dimensional rendering execution unit 48 may be implemented partially or entirely by an electronic device such as a graphics card. Further, it suffices that the above-mentioned functions are implemented by a hardware circuit or implemented by software on the electronic device.

Further, the roles to be played by the main processor 12, the sub-processor 14, and the image processing unit 20 according to this embodiment are not limited to the above-mentioned ones. For example, the pseudo-three-dimensional rendering execution unit 48 may be implemented by the image processing unit 20 or the main processor 12.

While there have been described what are at present considered to be certain embodiments of the invention, it will be understood that various modifications may be made thereto, and it is intended that the appended claims cover all such modifications as fall within the true spirit and scope of the invention.

What is claimed is:

1. An image processing apparatus, comprising:
a drawing unit that draws a raster image generated based on data serving as a basis of the raster image into a memory; and
a control unit that performs control as to which of the raster image drawn in the memory and a raster image for three-dimensional display based on the raster image drawn in the memory is to be displayed on a display device, in accordance with the drawing of the raster image based on the data into the memory.

2. The image processing apparatus according to claim 1, wherein the control unit causes the display device to display the raster image drawn in the memory under a condition that the raster image for three-dimensional display is drawn into the memory by the drawing unit.

3. The image processing apparatus according to claim 1, wherein the control unit causes the display device to display the raster image drawn in the memory under a condition that commands executed during a period from acquisition of the data serving as the basis of the raster image until the drawing of the raster image based on the data include a graphics command instructing to draw the raster image for three-dimensional display, and otherwise, causes the display device to display the raster image for three-dimensional display based on the raster image drawn in the memory.

4. The image processing apparatus according to claim 1, wherein the control unit causes the display device to display the raster image for three-dimensional display based on the raster image drawn in the memory under a condition that the commands executed during a period from acquisition of the data serving as the basis of the raster image until the drawing of the raster image based on the data include a command to decode encoded moving image data, and otherwise, causes the display device to display the raster image drawn in the memory.

5. The image processing apparatus according to claim 1, wherein the control unit performs the control based on a type of the memory in which the raster image is drawn by the drawing unit.

6. The image processing apparatus according to claim 1, wherein the control unit performs the control based on an attribute of the data or an attribute of the raster image.

7. The image processing apparatus according to claim 1, further comprising a raster image for three-dimensional display generation unit that generates the raster image for three-dimensional display based on the raster image drawn in the memory in a case where the control unit performs control to cause the display device to display the raster image for three-dimensional display based on the raster image drawn in the memory.

8. An image processing method, comprising:
drawing a raster image generated based on data serving as a basis of the raster image into a memory; and
performing control as to which of the raster image drawn in the memory and a raster image for three-dimensional display based on the raster image drawn in the memory is to be displayed on a display device, in accordance with the drawing of the raster image based on the data into the memory.

9. A program stored in a non-transitory computer readable information storage medium, which is to be executed by a computer, the program including instructions to:
draw a raster image generated based on data serving as a basis of the raster image into a memory; and
perform control as to which of the raster image drawn in the memory and a raster image for three-dimensional display based on the raster image drawn in the memory is to be displayed on a display device, in accordance with the drawing of the raster image based on the data into the memory.

10. A non-transitory computer readable information storage medium storing a program which is to be executed by a computer, the program including instructions to:
draw a raster image generated based on data serving as a basis of the raster image into a memory; and
perform control as to which of the raster image drawn in the memory and a raster image for three-dimensional display based on the raster image drawn in the memory is to be displayed on a display device, in accordance with the drawing of the raster image based on the data into the memory.
